(19) United States
(12) Patent Application Publication
(10) Pub. No.: US 2007/0293989 A1
(43) Pub. Date: Dec. 20, 2007

(54) Multiple mode system with multiple controllers

(75) Inventor: William Robert Norris, Rock Hill, SC (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/452,733

(22) Filed: Jun. 14, 2006

(51) Int. Cl. G06F 19/00

(52) U.S. Cl. 700/249; 700/245

(57) ABSTRACT

The present invention relates to a system and method for intelligent mobile vehicles that can be used in unmanned robotic or manned modes, the system having a plurality of controllers, with a low-level controller that controls basic operating functions for the mobile vehicles, and a high-level controller used to issue commands for unmanned robotic operation. Division of features between different controllers enables an ability to operate the mobile vehicle even if the high-level controller should fail or experience faults.

### FIELD OF THE INVENTION

The present invention relates to a system and method for intelligent mobile equipment that can be used in unmanned or manned modes, the system having a plurality of controllers.

### BACKGROUND OF THE INVENTION

There is an increasing trend towards automated or semi-automated equipment being developed for a variety of uses, rather than the operator-controlled equipment that was previously used. In some situations, these are completely different equipment from what were previously used, and do not allow for any situations in which an operator can be present on or take over operation of the equipment. Such unmanned equipment is not always very reliable, based on the complexity of systems involved, the current status of computerized control, and uncertainty in various operating environments. Therefore, what is more commonly seen is a piece of equipment similar to previous operator-controlled equipment that also incorporates one or more operations that are automated, rather than operator-controlled. These types of equipment allow for more supervision and the ability of the operator to take over control when desirable or necessary.

Because of the more complex systems involved in unmanned robotic-control equipment, failures are more likely, and therefore the ability to provide at least some capability for operator control is preferable. In such situations, depending on the failures that occur, the operator may have only limited ability to perform various actions. In particular, the complex control systems required for automated operation cannot always be easily adapted to revert to operator-control.

Therefore, what is needed is a system that allows for automated control, but provides a quick and easy method for an operator to assume control of the mobile equipment in situations where the automated control system fails or experiences faults.

### SUMMARY OF THE INVENTION

The present invention, accordingly, provides a method and system for both automated and manual control of mobile equipment, providing for the ability to manually control the equipment even when the automated control system experiences failures or faults. This is achieved by providing dual processors for controlling the system: one controller is a high-level, or automated controller, and the second controller, which is not just a redundant control system, is a low-level controller that serves as a supervisory controller for the equipment and performs equipment-specific control functions. In the event of a failure or fault in the high-level controller, or operations controlled by the high-level controller, or if fully manual control is implemented, the low-level controller can be used for manual operation of the equipment. By careful division of feature control into the high-level controller and low-level controller, avoidance of unnecessary duplication is achieved, reducing system cost. Such division can also enable using or reusing controller components in different equipment, or different types of equipment, thus reducing costs. Additionally, providing control of the automated functions in a separate controller can enable unmanned robotic equipment control to be an add-on feature, initially or at a later time.

It can be appreciated that various arrangements of the present invention would be useful in different environments or with different equipment or users. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

The invention disclosed is for a control system for controlling an object capable of movement, the control systems capable of performing arithmetic and logic operations, the control system having at least two controllers for controlling the object. The control system including a first controller comprising at least a microprocessor that performs at least some object functions and provides object supervisory control, a second controller comprising at least a microprocessor that controls at least some unmanned robotic object operations, and at least one interface layer for translating information that is communicated between the first and second controllers. The first controller is capable of providing control for the object sufficient to be able to move the object if the second controller is incapable of normal operation.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic representation of a system of the present invention for controlling a moving object;

FIG. 2 is a block diagram of communications between the various controllers of the present invention;

FIG. 3 is a representation of a typical dual-controller system of the present invention;

FIG. 4 is a schematic representation of an exemplary system for controlling moving objects of the present invention;

FIG. 5A is a schematic representation showing interchangeability of parts of the dual-controller system of the present invention between different vehicles; and

FIG. 5B is a schematic representation showing transfer of data from one dual-controller system of the present invention to a different dual-controller system of the present invention.

### DESCRIPTION OF THE PREFERRED EMBODIMENT

In the discussion of the FIGURES the same reference numerals will be used throughout to refer to the same or similar components. In the interest of conciseness, various other components known to the art, such as computer processing and storage mechanisms and the like necessary for the operation of the invention, have not been shown or discussed, or are shown in block form.

In the following, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning computer and database operation and the like have been omitted when such details are not considered necessary to obtain a complete understanding of the present invention, and are considered to be within the knowledge of persons of ordinary skill in the relevant art.

In the discussion that follows, the phrase “vehicle” means any piece of mobile equipment, having a broader definition than just equipment that operates on the ground with wheels having a portion thereof dedicated to space for an operator to stand or sit while controlling operation thereof.

Refer now to the drawings wherein depicted elements are, for the sake of clarity, not necessarily shown to scale and wherein like or similar elements are designated by the same reference numeral through the several views.

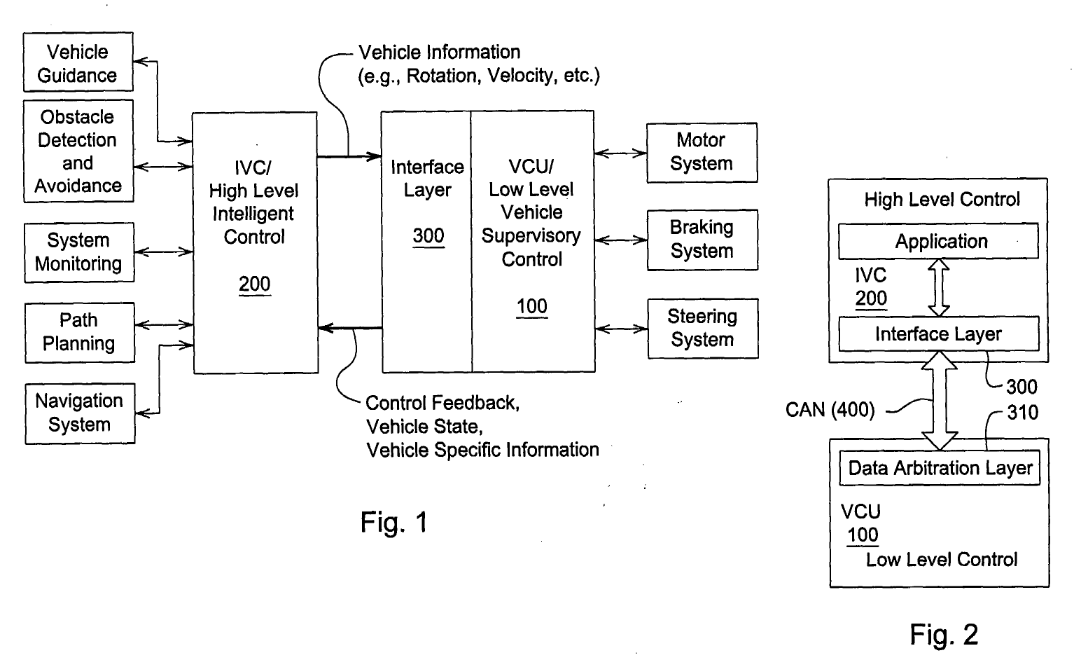

FIG. 1 shows a system 1 of the present invention for controlling a moving object, or vehicle. The system includes a Vehicle Control Unit (VCU) controller 100 for control of low-level functions and to provide vehicle supervisory control. The VCU 100 performs traditional vehicle safety and control functions, and is responsible for coordinating low-level vehicle control tasks and managing the loop of the low-level physical interfaces, such as communication with the motor, steering system, braking system, throttle, hydraulics, etc. Because the information being processed in the VCU 100 is typically not high-volume and does not require continuous rapid and complex calculations, it may be possible that the microprocessor used, while capable of performing the arithmetic and logic operations required, can be a less expensive device, which can reduce system costs.

The system 1 of the present invention also incorporates an Intelligent Vehicle Control controller (IVC) 200, a high-level intelligent controller that controls high-level unmanned, robotic vehicle operations, including such items as obstacle detection and avoidance features, path planning, vehicle guidance, sensor integration, system monitoring, and navigation and localization functions. Because of the volume of information processed and analyzed, the IVC 200 typically incorporates a high-speed, powerful microprocessor capable of performing rapid complex calculations for arithmetic and logic operations.

As shown in FIG. 2, typically, there is at least one translation or interface layer 300 that takes the high-level processing information and breaks it down to low-level commands, simulating operator actions. This can be done in a variety of ways, with the two most common being a virtual operator interface, such as a simulated control. In this type of system, the IVC 200 virtually controls the vehicle, with commands that imitate those of a physical interface. Another approach is for the high-level commands from the IVC 200 to be sent to the VCU 100. The VCU 100 then translates the commands into commands that can provide vehicle control. Depending on the type of system utilized, the translation layer 300 can reside in the IVC 200, the VCU 100, or both for systems with more than one translation layer 300. In the arrangement shown in FIG. 2, the Interface Layer 30b, which resides on the IVC 200, converts IVC outputs to values having units used and accepted by the data arbitration layer 310 on the VCU 100, and sends and receives messages over the communication network 400, which in this case is a CAN bus network. However, it can be appreciated that other arrangements of the communication systems can be used.

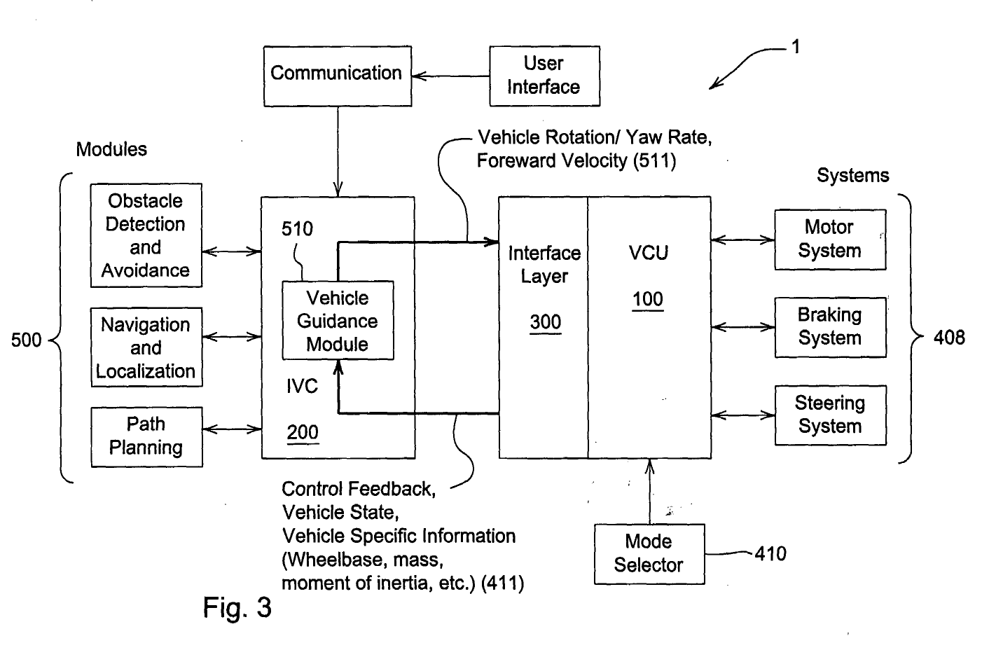

FIG. 3 is a representation of a typical dual-controller system 1 of the present invention. The system includes an IVC 200, which has, or communicates with modules 500 responsible for navigation and localization, obstacle detection and avoidance, path planning and vehicle guidance for unmanned robotic operation. The vehicle guidance module 510 also provides information 511 about vehicle movement, such as rotation and yaw rate and forward velocity to the interface layer 300, which is located in the VCU 100. The VCU 100 is responsible for operation of the steering, propulsion and braking systems 408 of the vehicle 10. The mode selector 410 provides input to the VCU 100 as to whether the vehicle 10 is operating in unmanned robotic or manual mode. In addition to controlling the steering, propulsion and braking system, the VCU 100 also provides information about the vehicle 10 to the IVC 200 via the interface layer 300. Such information includes, but is not limited to, control feedback, vehicle state information, and vehicle specific information such as the vehicle mass, moment of inertia. etc.

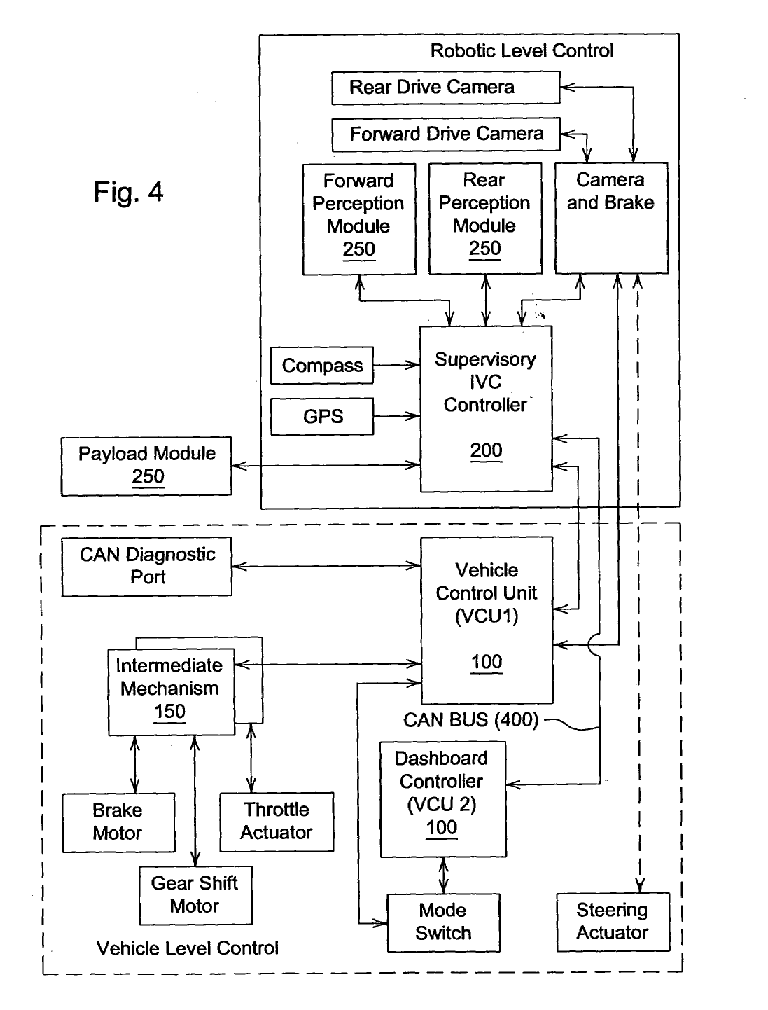

FIG. 4 discloses an example of a system 1 of the present invention. In this example, a vehicle has a dual controller of the present invention. The system 1 has a VCU 100 that is responsible for controlling lighting, steering, the throttle actuator, gear shift motor and brake motor, with intermediate mechanisms 150 for controlling the motors and throttle. The system 1 has a secondary VCU 100′ located in the operator compartment of the vehicle that provides an interface for the vehicle operator. The system 1 also has an IVC 200 that is used to control the vehicle when it is being operated as an unmanned robotic vehicle. In this example, the IVC 200 interfaces with various positioning and perception modules 250 that are used to determine the position of the vehicle, and to scan the area around the vehicle and identify any obstructions in the path of the vehicle and determine if the obstruction should be avoided when the vehicle is being operated in unmanned robotic mode. These modules 250 are used to determine a path, speed and parameters for the vehicle when it is being operated as an unmanned robotic vehicle. In operation, if the vehicle is operating in an unmanned robotic mode, the IVC 200 is controlling vehicle motion. If the IVC 200 should malfunction, or if the IVC 200 should perceive that the vehicle should not proceed in any direction, it will send a signal to the VCU 100 that it is not capable of operating, and will turn over control of the vehicle to the VCU 100. The VCU 100 does not have the equipment necessary to operate the vehicle 10 autonomously. However, it or the IVC 200 can send a message to the operator that operation of the vehicle has been transferred to the VCU 100. The operator can then operate the vehicle manually via the VCU 100, completing the operation that was being performed by the IVC 200, or bringing the vehicle to a safe location where it can be shut down and repaired.

Another advantage of the present invention is that the separation of high-level and low-level control functions into two separate and distinct controllers is the simplification of repairs and system upgrades. If a system that has a VCU 100 but is not initially outfitted with a IVC 200, is subsequently desired to be used as an unmanned robotic system, then depending on the arrangement and configuration of the VCU 100 in the original system, an IVC 200 can be added on and connected into the VCU 100 via the CAN Bus 400, and the system 1 can become a system that has both manual and automated functions. Another improvement achieved by the modular system 1 of the present invention is simplification of repairs. If a system of the present invention experiences a failure of the IVC 200, the system can be operated in manual or semi-automated mode using just the VCU 100. This can be achieved by the system 1 recognizing the IVC failure and sending a signal to the VCU 100 to function without the IVC, or such override can be achieved manually by an operator input. After properly shutting down the system, the IVC unit 200 can be removed and replaced with a new IVC 200, without the need to replace the VCU 100 or various individual components. Any vehicle-specific programming in the IVC 200 can be downloaded to the new IVC 200, or in some arrangements of the present invention, such vehicle-specific data is stored in the VCU 100 to further enable such quick and easy repairs.

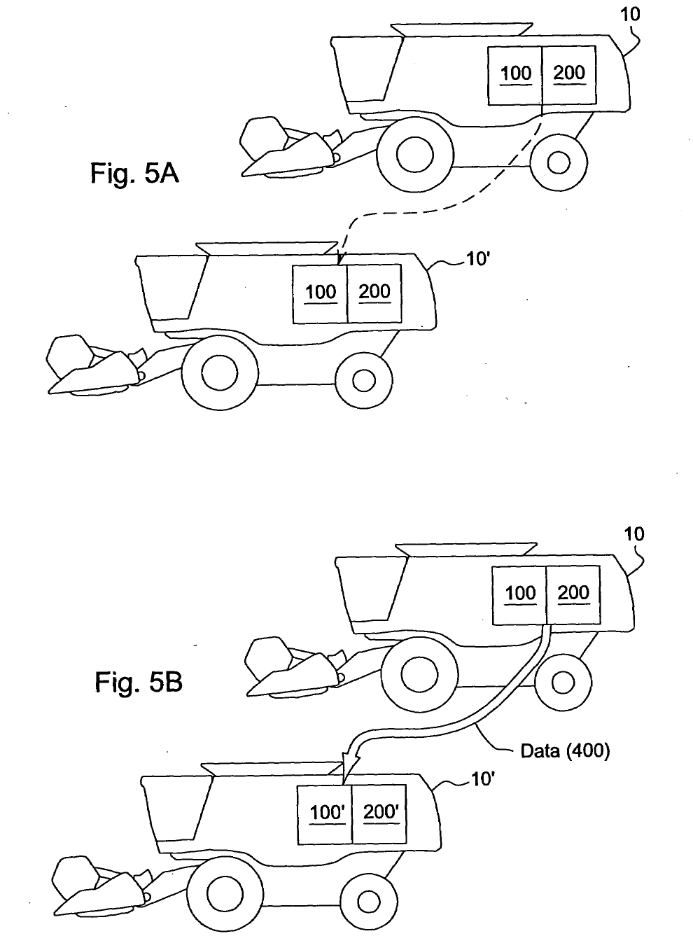

Yet another improvement achieved by the modularity of the present invention is the ability to move individual controllers from one system to another. For example, as shown in FIG. 5A an unmanned robotic vehicle 10 is used in a specific operation, and the vehicle 10 has acquired certain mission-specific knowledge related to the operation. If a new vehicle 10′ is to be used in the same operation to replace the first vehicle 10, the controller or controllers 100, 200 from the first vehicle 10 may be removed from the first vehicle 10 and installed in the second vehicle 10′ to enable the second vehicle 10′ to perform the operations. It can be appreciated that certain minor modifications or machine-learning may be required to ensure the second vehicle 10′ performs the operation satisfactorily, especially if the second vehicle 10′ differs from the first vehicle 10 in any characteristics. Similarly, as shown in FIG. 5B, if a new vehicle 10′ is to be used to perform a similar operation to that performed by a first vehicle 10 that has already learned the operation, data can be transferred via the CAN bus 400 from the controller or controllers 100, 200 of the first vehicle 10 to the controller or controllers 100′, 200′ of the second vehicle 10′, which can significantly reduce the time needed to train the second vehicle 10′ to perform the same operations already learned by the first vehicle 10.

It is understood that the present invention can take many forms and embodiments. Accordingly, several variations may be made in the foregoing without departing from the spirit or the scope of the invention. Having described the preferred embodiment, it will become apparent that various modifications can be made without departing from the scope of the invention as defined in the accompanying claims.

I claim:

1. A control system for controlling an object capable of movement, the control systems capable of performing arithmetic and logic operations, the control system comprising:
at least two controllers for controlling the object, including a first controller comprising at least a microprocessor that performs at least some object functions and provides object supervisory control;
a second controller comprising at least a microprocessor that controls at least some unmanned robotic object operations,
at least one interface layer for translating information that is communicated between the first and second controllers;
the first controller capable of providing control for the object sufficient to be able to move the object if the second controller is incapable of normal operation.

2. A method of controlling an object capable of movement comprising:
providing at least two microprocessor-based controllers for controlling the object, the first controller capable of providing supervisory object control and performing some object functions, the second controller controlling at least some unmanned robotic object operations;
providing an interface layer for translating information communicated between the first and second controllers;
providing a communication network that transmits information from the first and second controllers to the object so as to control object movement
dividing operations controlled between the first and second controllers such that if the second controller does not operate, the first controller can control manual object operation.

3. A moving object having at least two controllers, wherein
the first controller comprises at least one microprocessor capable of performing arithmetic and logic calculations sufficient to control manual operation of the moving object;
the second controller comprises at least one microprocessor capable of performing arithmetic and logic calculations sufficient to control unmanned robotic operation of the moving object;
the first and second controllers capable of communicating with each other by means of an interface layer;
the first controller capable of performing sufficient functions such that if the second controller does not operate, the first controller is capable of providing control to enable manual operation of the moving object.
